(19) United States
(12) Patent Application Publication
(10) Pub. No.: US 2026/0175815 A1
(43) Pub. Date: Jun. 25, 2026

(54) DOOR LOCK CONTROL DEVICE AND DOOR LOCK CONTROL METHOD

(71) Applicant: Mitsubishi Electric Corporation, Tokyo (JP)

(72) Inventor: Takamasa KUDOMI, Tokyo (JP)

(73) Assignee: Mitsubishi Electric Corporation, Tokyo (JP)

(21) Appl. No.: 18/839,732

(22) PCT Filed: Apr. 7, 2022
(86) PCT No.: PCT/JP2022/017218

§ 371 Date: Aug. 20, 2024

(51) Int. Cl. B60R 25/31

(52) U.S. Cl. CPC B60R 25/31

(57) ABSTRACT

The door lock control device includes: an extra-vehicle object detection unit to detect an extra-vehicle object that approaches a door of a vehicle from outside the vehicle; a qualification determination unit to determine whether or not the detected extra-vehicle object is a qualified object that is qualified to unlock a door that is locked, and output a determination result; and a door control instruction unit to, when the door that the detected extra-vehicle object approaches is a locked door that is locked, output a control signal for instructing an operation on the locked door on the basis of the output determination result, and, when it is determined that the detected extra-vehicle object is the qualified object, the door control instruction unit outputs a control signal for instructing unlocking of the locked door.

### TECHNICAL FIELD

The present disclosure relates to a door lock control technique.

### BACKGROUND ART

Patent Literature 1 discloses a vehicle keyless entry system that includes an in-vehicle device and a portable device. When each of a plurality of antennas transmits a reply request signal in response to an activation request of in-vehicle equipment, the in-vehicle device adds to the reply request signal an antenna ID of each antenna that transmits the reply request signal to transmit. Subsequently, the portable device transmits a reply transmission signal to which the antenna ID added to the received response request signal and a portable device ID have been added. Subsequently, the in-vehicle device refers to a table on the basis of the portable device ID and the antenna ID added to the replied transmission signal, and activates the in-vehicle equipment for which the activation request has been made in a case where the antenna ID is an antenna ID that is activation requirement of the in-vehicle equipment for which the activation request has been made, and the portable device ID is a portable device ID that is permitted to activate the in-vehicle equipment for which the activation request has been made.

### CITATION LIST

### Patent Literature

Patent Literature 1: JP 2016-211358 A

### SUMMARY OF INVENTION

### Technical Problem

The technique described in Patent Literature 1 involves communication with the portable device to activate the in-vehicle equipment, and therefore has a problem that the portable device is necessary to unlock doors of a vehicle.

The present disclosure has been made in response to the recognition of such a problem, and an object of one aspect of embodiments of the present disclosure is to provide a door lock control device that can unlock doors of a vehicle without a mobile terminal.

### Solution To Problem

One aspect of a door lock control device according to an embodiment of the present disclosure includes: an extra-vehicle object detection unit to detect an extra-vehicle object that approaches a door of a vehicle from outside the vehicle; a qualification determination unit to determine whether or not the detected extra-vehicle object is a qualified object that is qualified to unlock a door that is locked, and output a determination result; and a door control instruction unit to, when the door that the detected extra-vehicle object approaches is a locked door that is locked, output a control signal for instructing an operation on the locked door on a basis of the output determination result, and, when it is determined that the detected extra-vehicle object is the qualified object, the door control instruction unit outputs a control signal for instructing unlocking of the locked door.

### Advantageous Effects of Invention

According to one aspect of a door lock control device according to one aspect of the embodiments of the present disclosure, it is possible to unlock doors of a vehicle without a mobile terminal.

### BRIEF DESCRIPTION OF DRAWINGS

FIG. 1 is a view illustrating a configuration example of a door lock control device and a door lock control system according to Embodiment 1.

FIG. 2A is a view illustrating a hardware configuration example of the door lock control device.

FIG. 2B is a view illustrating a hardware configuration example of the door lock control device.

FIG. 3 is a flowchart illustrating an example of a lock operation of the door lock control device.

FIG. 4 is a flowchart illustrating an example of an unlock operation of the door lock control device.

FIG. 5 is a view illustrating a configuration example of a door lock control device and a door lock control system according to Embodiment 2.

### DESCRIPTION OF EMBODIMENTS

Various embodiments of the present disclosure will be described in detail below with reference to the accompanying drawings. Note that components assigned the identical or similar reference numerals in the drawings will have identical or similar components or functions, and redundant description of these components will be omitted.

### Embodiment 1

### <Configuration>

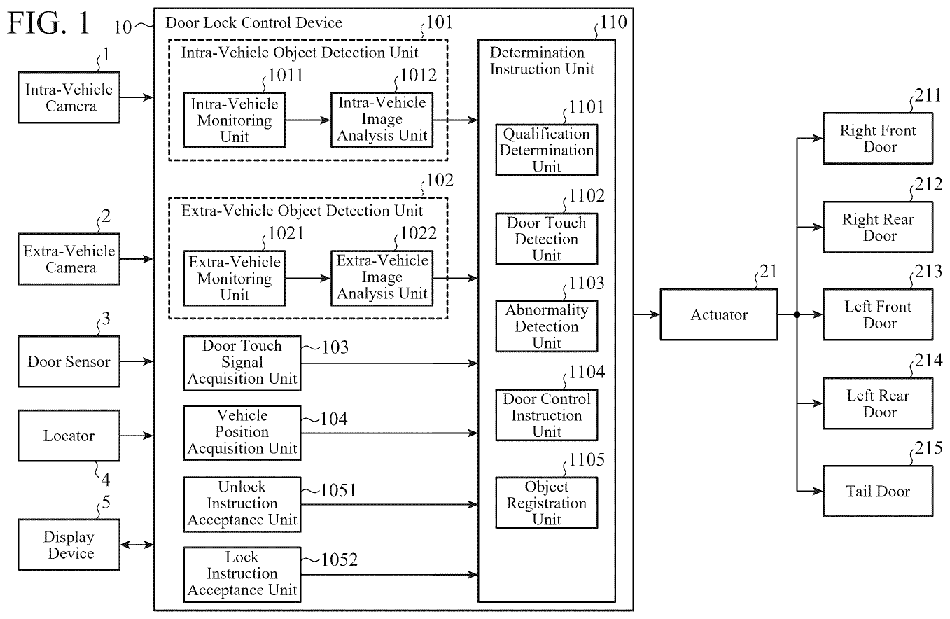

A configuration of a door lock control device 10 according to Embodiment 1 of the present disclosure will be described with reference FIG. 1. FIG. 1 is a view illustrating a configuration example of a door lock control system including the door lock control device 10. The door lock control system is mounted on a vehicle and used. The vehicle includes a plurality of seats and a plurality of doors. Examples of the plurality of doors include a right front door 211 on a right front side of the vehicle, a right rear door 212 on a right rear side of the vehicle, a left front door 213 on a left front side of the vehicle, a left rear door 214 on a left rear side of the vehicle, and a tail door 215 provided at an end part of the vehicle. In the present disclosure, the tail door 215 is a concept that includes a lid of a trunk room of the vehicle or a tail gate of the vehicle.

As illustrated in FIG. 1, the door lock control system includes the door lock control device 10 and peripheral devices connected to the door lock control device 10. As illustrated in FIG. 1, the peripheral devices include an intra-vehicle camera 1, an extra-vehicle camera 2, a door sensor 3, a locator 4, a display device 5, and an actuator 21.

### (Intra-Vehicle Camera)

The intra-vehicle camera 1 is a camera that captures images inside the vehicle and generates intra-vehicle images. The intra-vehicle camera 1 outputs the generated intra-vehicle images to the door lock control device 10. The vehicle may be provided with a plurality of the intra-vehicle cameras 1.

### (Extra-Vehicle Camera)

The extra-vehicle camera 2 is a camera that captures images outside the vehicle and generates extra-vehicle images. The extra-vehicle camera 2 outputs the generated extra-vehicle images to the door lock control device 10. The vehicle may be provided with a plurality of the extra-vehicle cameras 2. Furthermore, the plurality of the extra-vehicle cameras 2 may implement a surround view function.

### (Door Sensor)

The door sensor 3 is a sensor that is provided on an external side surface of each door of the vehicle, and detects a touch operation of touching a door of the vehicle. The door sensor 3 may be a mechanical sensor that detects an actual touch, or may be a capacitive sensor that detects approach of a human hand on the basis of change in the capacitance. The door sensor 3 may be provided to a metal part such as a door knob of the door or may be provided to a window of the door. When detecting the touch operation, the door sensor 3 outputs to the door lock control device 10 a door touch signal indicating that the touch operation has been detected.

### (Locator)

The locator 4 is a device that specifies a current position of the vehicle. The locator 4 is, for example, a Global Navigation Satellite System (GNSS) sensor. The locator 4 outputs to the door lock control device 10 position information indicating the specified current position of the vehicle.

### (Display Device)

The display device 5 is a user interface that displays images and information for passengers of the vehicle, and accepts a user input. Examples of the user input to be accepted include an unlock instruction indicating to unlock a locked door, and a lock instruction indicating to lock a specific door. The display device 5 outputs the accepted user input to the door lock control device 10.

### (Actuator)

The actuator 21 is an actuator that opens or closes the doors of the vehicle.

### (Door Lock Control Device)

As illustrated in FIG. 1, the door lock control device 10 includes an intra-vehicle object detection unit 101, an extra-vehicle object detection unit 102, a door touch signal acquisition unit 103, a vehicle position acquisition unit 104, an unlock instruction acceptance unit 1051, a lock instruction acceptance unit 1052, and a determination instruction unit 110.

### (Intra-Vehicle Object Detection Unit)

The intra-vehicle object detection unit 101 is a function unit that performs image processing on the intra-vehicle images output from the intra-vehicle camera 1, and detects a human sitting at each seat or an animal or luggage other than the human at each seat. To implement such a function, the intra-vehicle object detection unit 101 includes an intra-vehicle monitoring unit 1011 and an intra-vehicle image analysis unit 1012.

The intra-vehicle monitoring unit 1011 acquires the intra-vehicle images generated by the intra-vehicle camera 1, and transmits the acquired intra-vehicle images to the intra-vehicle image analysis unit 1012.

The intra-vehicle image analysis unit 1012 receives the intra-vehicle images transmitted from the intra-vehicle monitoring unit 1011, and analyzes the received intra-vehicle images. More specifically, the intra-vehicle image analysis unit 1012 analyzes the intra-vehicle images, determines whether or not an intra-vehicle object is in an intra-vehicle image, and identifies the attribute of the intra-vehicle object when there is the intra-vehicle object. That is, the intra-vehicle image analysis unit 1012 identifies which one of an adult, a child, a pet, or luggage the intra-vehicle object is. Furthermore, in a case where the intra-vehicle object is the adult, the intra-vehicle image analysis unit 1012 extracts a feature of this adult. The intra-vehicle image analysis unit 1012 performs identification processing on the intra-vehicle object per seat of the vehicle. Furthermore, the intra-vehicle image analysis unit 1012 may detect an abnormality inside the vehicle by the image processing. The intra-vehicle image analysis unit 1012 detects the abnormality inside the vehicle by detecting collapse of a posture of a driver. The intra-vehicle image analysis unit 1012 transmits an analysis result to the determination instruction unit 110.

### (Extra-Vehicle Object Detection Unit)

The extra-vehicle object detection unit 102 is a function unit that performs image processing on the extra-vehicle images output from the extra-vehicle camera 2, and detects an extra-vehicle object that approaches a locked door which is locked from outside the vehicle. By disposing the extra-vehicle camera 2 in such a way that the extra-vehicle camera 2 images the surroundings of the vehicle, it is possible to perform the image processing on the extra-vehicle images output from the extra-vehicle camera 2, and detect the extra-vehicle object that approaches the locked door which is locked from outside the vehicle. To implement such a function, the extra-vehicle object detection unit 102 includes an extra-vehicle monitoring unit 1021 and an extra-vehicle image analysis unit 1022.

The extra-vehicle monitoring unit 1021 acquires the extra-vehicle images generated by the extra-vehicle camera 2, and transmits the acquired extra-vehicle images to the extra-vehicle image analysis unit 1022.

The extra-vehicle image analysis unit 1022 receives the extra-vehicle images transmitted from the extra-vehicle monitoring unit 1021, and analyzes the received extra-vehicle images. More specifically, the extra-vehicle image analysis unit 1022 analyzes an extra-vehicle image, estimates a distance of the extra-vehicle object shown in the extra-vehicle image from the vehicle, and extracts a feature of the extra-vehicle object by a known technique. The extra-vehicle image analysis unit 1022 can estimate the distance from the vehicle to the extra-vehicle object on the basis of the size of the imaged extra-vehicle object. The extra-vehicle image analysis unit 1022 transmits an analysis result to the determination instruction unit 110.

### (Door Touch Signal Acquisition Unit)

The door touch signal acquisition unit 103 acquires the door touch signal from the door sensor 3, and outputs a door specifying signal indicating the touched door to the determination instruction unit 110.

### (Vehicle Position Acquisition Unit)

The vehicle position acquisition unit 104 is a function unit that acquires the position output by the locator, and transmits the acquired position information to the determination instruction unit 110.

### (Unlock Instruction Acceptance Unit)

The unlock instruction acceptance unit 1051 accepts the unlock instruction output from the display device 5 on the basis of the user input, and transmits the accepted unlock instruction to the determination instruction unit 110. The unlock instruction acceptance unit 1051 may accept a non-unlock instruction for not performing unlocking, and transmit the accepted non-unlock instruction to the determination instruction unit 110.

### (Lock Instruction Acceptance Unit)

The lock instruction acceptance unit 1052 accepts the lock instruction output from the display device 5 on the basis of the user input, and transmits the accepted lock instruction to the determination instruction unit 110. The lock instruction instructs to lock a door closest to an empty seat. By locking the door meeting the empty seat in accordance with such a lock instruction, it is possible to prevent an incident that a child is kidnapped through a door that is not locked.

### (Determination Instruction Unit)

The determination instruction unit 110 is a function unit that determines whether or not to lock or unlock the door on the basis of various information, and outputs a control signal for locking or unlocking the door. To implement such a function, the determination instruction unit 110 includes, for example, a qualification determination unit 1101, a door touch detection unit 1102, an abnormality detection unit 1103, a door control instruction unit 1104, and an object registration unit 1105.

### (Qualification Determination Unit; Object Registration Unit)

The qualification determination unit 1101 is a function unit that determines whether the detected extra-vehicle object is a qualified object that is qualified to unlock the locked door or an unqualified object that is not qualified to unlock the locked door, and outputs a determination result. Qualification is determined by comparing the extra-vehicle object indicated by the analysis result output from the extra-vehicle image analysis unit 1022 and a qualification table in which qualified objects are registered in advance. Examples of the qualified objects include a driver of the vehicle, an adult who is a passenger of the vehicle, and a pre-registered person who is registered in advance by a user input. The qualification table is created by the object registration unit 1105 on the basis of the user input or on the basis of a result of image analysis of the intra-vehicle object detection unit 101 at a time of getting on the vehicle. The created qualification table is stored in an unillustrated memory, and is referred to as appropriate. The memory that stores the qualification table may be included in the door lock control device 10, or may be provided outside the door lock control device 10.

### (Door Touch Detection Unit)

The door touch detection unit 1102 is a function unit that determines whether or not a touch operation is performed on the locked door, which is locked, from outside the vehicle, and outputs a determination result. Whether or not the touch operation is performed is determined on the basis of the door specifying signal transmitted from the door touch signal acquisition unit 103 and indicating the touched door, and a door state table that records an opened/closed state of each door. The door state table is created on the basis of a detection signal from an unillustrated sensor that detects that the door is opened or closed.

### (Abnormality Detection Unit)

The abnormality detection unit 1103 is a function unit that detects an abnormality inside the vehicle, and outputs a detection result. For example, the abnormality detection unit 1103 detects that there is the abnormality inside the vehicle when the intra-vehicle image analysis unit 1012 outputs an analysis result indicating collapse of the posture of the driver.

### (Door Control Instruction Unit)

The door control instruction unit 1104 is a function unit that outputs a control signal for instructing to lock or unlock the door of the vehicle on the basis of a processing result of each function unit such as a determination result of qualification determination performed by the qualification determination unit 1101.

For example, when the intra-vehicle object detected by the intra-vehicle object detection unit 101 is a predetermined object, the door control instruction unit 1104 outputs a control signal for instructing locking of a door closest to the detected intra-vehicle object. The predetermined object is, for example, a child, an animal other than a human, or luggage. For example, the door control instruction unit 1104 outputs a control signal for instructing locking of a door closest to a seat on which a child sits, on the basis of a detection result indicating that the intra-vehicle object detected by the intra-vehicle object detection unit 101 is the child. For example, the door control instruction unit 1104 outputs a control signal for instructing locking of a door closest to a seat on which an animal exists, on the basis of a detection result indicating that the intra-vehicle object detected by the intra-vehicle object detection unit 101 is the animal other than a human. For example, the door control instruction unit 1104 outputs a control signal for instructing locking of a door closest to a seat on which luggage is placed, on the basis of a detection result indicating that the intra-vehicle object detected by the intra-vehicle object detection unit 101 is the luggage.

For example, the door control instruction unit 1104 outputs a control signal for instructing locking of a door designated by the lock instruction on the basis of the lock instruction transmitted from the lock instruction acceptance unit 1052.

For example, when it is determined that the determination result output from the qualification determination unit 1101 indicates determination that the detected extra-vehicle object is a qualified object, the door control instruction unit 1104 outputs a control signal for instructing unlocking of a locked door, which is locked. Examples of the qualified objects include a driver of the vehicle, an adult who is a passenger of the vehicle, and a pre-registered person who is other than passengers of the vehicle and is registered in advance. Whether the door is locked or unlocked is detected by the unillustrated door sensor that detects the opened/closed state of the door, and the door control instruction unit 1104 refers to a detection result. The actuator 21 unlocks the instructed locked door in accordance with an output control signal. Consequently, it is possible to unlock a door of a vehicle even if there is no mobile terminal by unlocking the locked door on the basis of the determination result output from the qualification determination unit 1101, that is, an image processing result. Furthermore, by limiting people who can unlock the locked door to certain people who are designated as a qualified object, it is possible to prevent a child or a pet from jumping outside the vehicle or being kidnapped, or prevent theft of luggage. Furthermore, by registering, for example, parents of the driver in advance as the pre-registered person, the parents who greet a driver's family when the driver's family return to a parents'home can approach to automatically unlock a door closest to a seat on which a child of the driver sits, and smoothly greet the driver's family. That is, complicated manual unlocking is unnecessary.

The door control instruction unit 1104 may output a control signal for instructing an operation of the locked door on the basis of, for example, not only the determination result output from the qualification determination unit 1101, but also the detection result of the door touch detection unit 1102. When, for example, the detected extra-vehicle object is the qualified object, and when it is determined that the touch operation is performed on the locked door from outside the vehicle, the door control instruction unit 1104 outputs a control signal for unlocking the locked door. Consequently, by limiting unlocking of the locked door to a case where the touch operation is performed, it is possible to provide higher security. For example, an example will be assumed where, when the driver has an intention of getting off the vehicle, unlocking the left rear door, and then unlocking the left front door, the driver gets off the vehicle, passes in front of the vehicle, passes the side of the left front door, and moves to the side of the left rear door. In a case of this example, unless a touch operation is performed on the left front door, the left front door is not unlocked, so that it is possible to prevent the left front door from being unlocked against the driver's intention.

The door control instruction unit 1104 may output a control signal for instructing unlocking of the locked door on the basis of, for example, the position information acquired from the vehicle position acquisition unit 104. By setting a predetermined position such as a home as an unlock position in advance, it is possible to unlock the door when the vehicle arrives at the unlock position from a place other than the unlock position.

The door control instruction unit 1104 may output a control signal for instructing unlocking of the locked door on the basis of, for example, the unlock instruction acquired from the unlock instruction acceptance unit 1051. When the extra-vehicle object is a person who is, for example, a friend of a passenger in the vehicle and can be trusted, such a person may unlock the locked door. Hence, when the extra-vehicle object detected by the extra-vehicle object detection unit 102 is not the qualified object, an unillustrated display control unit may cause the display device 5 to display whether or not to permit unlocking, the unlock instruction acceptance unit 1051 may accept an unlock instruction indicating unlock permission on the basis of a user input, and the door control instruction unit 1104 may output a control signal for instructing unlocking on the basis of the accepted unlock instruction.

Furthermore, when the unlock instruction acceptance unit 1051 accepts a non-unlock instruction, an unillustrated notification control unit included in the door lock control device 10 may perform notification control of an unillustrated speaker to notify the extra-vehicle object that the locked door is not to be unlocked.

For example, when an abnormality inside the vehicle is detected, the door control instruction unit 1104 may output the control signal for unlocking the locked door. When, for example, the abnormality detection unit 1103 detects the abnormality inside the vehicle, the door control instruction unit 1104 may output the control signal for instructing unlocking of the locked door. When an adult inside the vehicle cannot move due to an accident or the like, a person other than the qualified object needs to rescue the adult from outside the vehicle. To deal with such a situation, the door control instruction unit 1104 may output the control signal for unlocking the locked door when the abnormality inside the vehicle is detected.

A control instruction signal output from the door control instruction unit 1104 is sent to the actuator 21, and the actuator 21 locks or unlocks the door in accordance with the control instruction signal.

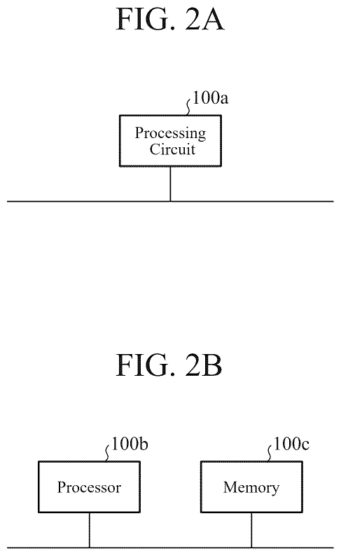

Next, the hardware configuration of the door lock control device 10 will be described with reference to FIGS. 2A and 2B. Each function unit of the door lock control device 10 is implemented by processing circuitry. The processing circuitry may be a dedicated processing circuit 100a illustrated in FIG. 2A, or may be a processor 100b that executes programs stored in a memory 100c illustrated in FIG. 2B.

In a case where the above processing circuitry is the dedicated processing circuit 100a, the dedicated processing circuit 100a corresponds to, for example, a single circuit, a composite circuit, a programmed processor, a parallel-programmed processor, an Application Specific Integrated Circuit (ASIC), a Field-Programmable Gate Array (FPGA), or a combination thereof. The function of each function unit of the door lock control device 10 may be implemented by a plurality of different processing circuits, or the functions of the functions units may be collectively implemented by a single processing circuit.

In a case where the processing circuitry is the processor 100b, each function unit of the door lock control device 10 may be implemented as software, firmware, or a combination of software and firmware. The software and the firmware are described as programs, and stored in the memory 100c. The processor 100b implements the function of each function unit by reading and executing the programs stored in the memory, Here, examples of the memory 100c include a non-volatile or volatile semiconductor memory such as a Random Access Memory (RAM), a Read-Only Memory (ROM), a flash memory, an Erasable Programmable Read Only Memory (EPROM), or an Electrically Erasable programmable Read-Only Memory (EEPROM), a magnetic disk, a flexible disk, an optical disk, a compact disk, a mini disk, and a DVD.

Note that part of the function units of the door lock control device 10 may be implemented as dedicated hardware, and part of the function units may be implemented as software or firmware. Thus, the processing circuit can implement each of the above-described function units as hardware, software, firmware, or a combination thereof.

### <Operation>

### (Lock Operation)

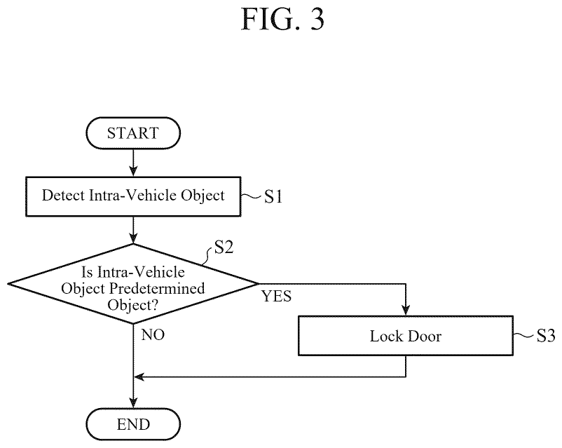

The operation of the door lock control device 10 will be described below. First, the lock operation of the door lock control device 10 will be described with reference FIG. 3.

In step S1, the intra-vehicle object detection unit 101 performs image processing on an intra-vehicle image output from the intra-vehicle camera 1, and detects a human or luggage sitting at each seat.

In step S2, the door control instruction unit 1104 determines whether or not the intra-vehicle object detected by the intra-vehicle object detection unit 101 is a predetermined object, and outputs a control signal for instructing locking of a door closest to the detected intra-vehicle object when the intra-vehicle object is the predetermined object. On the basis of this control signal, the actuator 21 locks the door for which locking has been instructed (step S3).

### (Unlock Operation)

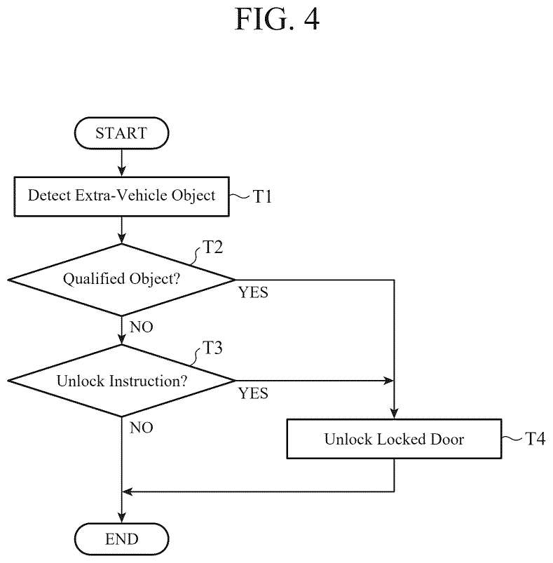

Next, an unlock operation of the door lock control device 10 will be described with reference FIG. 4. In step T1, the extra-vehicle object detection unit 102 performs image processing on an extra-vehicle image output from the extra-vehicle camera 2, and detects an extra-vehicle object that approaches a locked door, which is locked, from outside the vehicle.

In step T2, the qualification determination unit 1101 determines whether or not the detected extra-vehicle object is a qualified object that is qualified to unlock the locked door. In a case where the detected extra-vehicle object is the qualified object, the processing proceeds to step T4, and, in a case where the detected extra-vehicle object is not the qualified object, that is, the detected extra-vehicle object is an unqualified object, the processing proceeds to step T3.

In step T3, the door control instruction unit 1104 determines whether or not an unlock instruction for instructing unlocking of the locked door is accepted. In a case where the unlock instruction is accepted, the processing proceeds to step T4. In a case where the unlock instruction is not accepted, the processing is finished, for example. In another example, in a case where the unlock instruction is not accepted, the unillustrated notification control unit may perform notification control of the unillustrated speaker to notify the extra-vehicle object that the locked door is not to be unlocked. After such notification is performed, the processing is finished.

In step T4, the door control instruction unit 1104 outputs the control signal for instructing unlocking of the locked door. The actuator 21 unlocks the locked door in accordance with the control signal for instructing unlocking.

### Embodiment 2

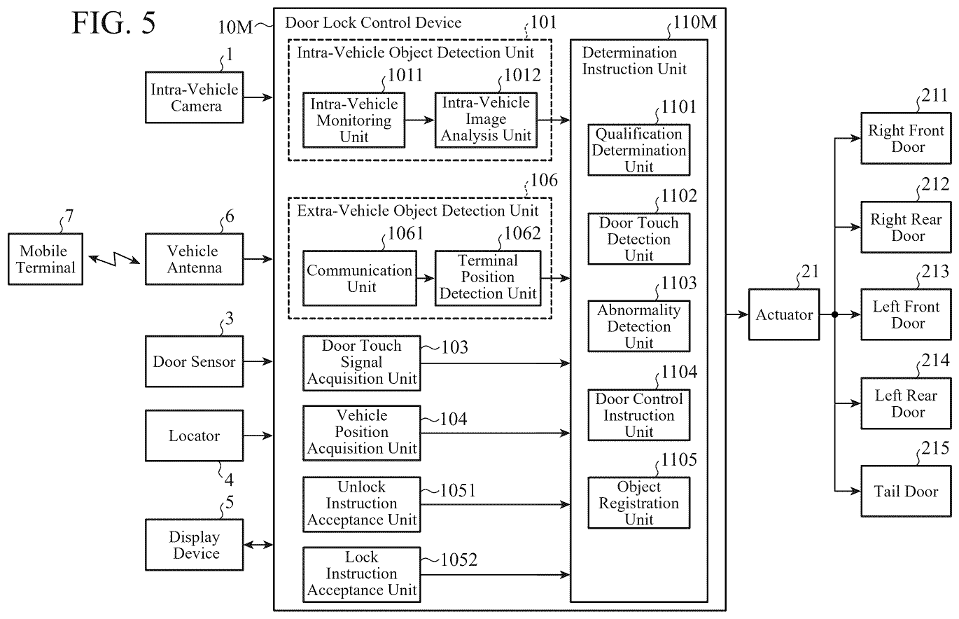

Next, a configuration of a door lock control device 10M according to Embodiment 2 of the present disclosure will be described with reference FIG. 5. The door lock control device 10M according to Embodiment 2 differs from the door lock control device 10 in including an extra-vehicle object detection unit 106 instead of the extra-vehicle object detection unit 102 according to Embodiment 1. Furthermore, a door lock control system according to Embodiment 2 differs from the door lock control system according to Embodiment 1 in including a vehicle antenna 6 instead of the extra-vehicle camera 2 according to Embodiment 1.

### (Vehicle Antenna)

The vehicle antenna 6 is an antenna that receives a radio signal of a mobile terminal 7 outside a vehicle. The at least one vehicle antenna 6 is disposed, and a receivable frequency band is appropriately set depending on a communication method.

### (Extra-Vehicle Object Detection Unit)

The extra-vehicle object detection unit 106 includes a communication unit 1061 and a terminal position detection unit 1062.

### (Communication Unit)

The communication unit 1061 is a function unit that transmits and receives radio waves to and from the mobile terminal 7 via the vehicle antenna 6. The communication unit 1061 wirelessly communicates with the mobile terminal 7 by a known communication method such as near field wireless communication. The communication unit 1061 transmits a received signal to the terminal position detection unit 1062.

### (Terminal Position Detection Unit)

The terminal position detection unit 1062 detects the position of the mobile terminal 7. The terminal position detection unit 1062 detects the mobile terminal 7 as the extra-vehicle object by detecting that the mobile terminal 7 outside the vehicle is within a range of a predetermined distance from the vehicle. When communication with the mobile terminal 7 is performed using a weak radio wave, it may be determined by detecting the radio wave from the mobile terminal 7 that the mobile terminal 7 is within the range of the predetermined distance. Furthermore, it may be determined on the basis of a radio wave intensity from the mobile terminal 7 that the mobile terminal 7 is within the range of the predetermined distance. The terminal position detection unit 1062 transmits terminal position information indicating the detected position of the mobile terminal 7 to a determination instruction unit 110M.

The determination instruction unit 110M executes a function similar to that of the determination instruction unit 110 according to Embodiment 1. In this regard, in a qualification table that a qualification determination unit 1101 refers to, the mobile terminal 7 that is permitted to perform the operation of unlocking the locked door needs to be registered in advance as a qualified object. An example of the qualified object includes the mobile terminal 7 of a driver of the vehicle or the mobile terminal 7 of an adult who is a passenger of the vehicle.

Since a hardware configuration of the door lock control device 10M is the same as the hardware configuration of the door lock control device 10 according to Embodiment 1, redundant description will be omitted.

An operation of the door lock control device 10M is substantially the same as the operation of the door lock control device 10 according to Embodiment 1. In this regard, in a case of the operation of the door lock control device 10M, detection of an extra-vehicle object in step Tl is performed by the extra-vehicle object detection unit 106, and the qualification table referred to in step T2 includes the mobile terminal of the driver of the vehicle or the mobile terminal 7 of the adult who is the passenger of the vehicle as the qualified object.

Although the conventional technique according to Patent Literature I can unlock a door of a vehicle when a registered portable device is held, it is possible to enhance a security level by adding requirement that the qualified object is the driver of the vehicle or the adult who is the passenger of the vehicle similar to the door lock control device 10M according to Embodiment 2.

### Supplementary Notes

Next, some aspects of the embodiments of the present disclosure will be briefly organized as supplementary notes.

### <Supplementary Note 1>

A door lock control device according to supplementary note 1 includes: an extra-vehicle object detection unit (102; 106) to detect an extra-vehicle object that approaches a door of a vehicle from outside the vehicle; a qualification determination unit (1101) to determine whether or not the detected extra-vehicle object is a qualified object that is qualified to unlock a door that is locked, and output a determination result; and a door control instruction unit (1104) to, when the door that the detected extra-vehicle object approaches is a locked door that is locked, output a control signal for instructing an operation on the locked door on the basis of the output determination result, and, when it is determined that the detected extra-vehicle object is the qualified object, the door control instruction unit outputs a control signal for instructing unlocking of the locked door.

### <Supplementary Note 2>

A door lock control device according to supplementary note 2 is the door lock control device described in supplementary note 1, and further includes a door touch detection unit (1102) to detect that a touch operation is performed on the door of the vehicle from outside the vehicle, and, when it is determined that the detected extra-vehicle object is the qualified object, and when the touch operation is detected, the door control instruction unit outputs the control signal for instructing the unlocking of the locked door.

### <Supplementary Note 3>

A door lock control device according to supplementary note 3 is the door lock control device described in supplementary note 1 or 2, and the extra-vehicle object detection unit includes an extra-vehicle image analysis unit (1022) to detect a human who approaches from outside the vehicle as the extra-vehicle object by performing image processing on an extra-vehicle image generated by an extra-vehicle camera that captures images outside the vehicle.

### <Supplementary Note 4>

A door lock control device according to supplementary note 4 is the door lock control device described in any one of supplementary notes 1 to 3, and the qualified object includes a driver of the vehicle, an adult who is a passenger of the vehicle, or a pre-registered person who is other than the passenger of the vehicle and is registered in advance.

### <Supplementary Note 5>

A door lock control device according to supplementary note 5 is the door lock control device described in any one of supplementary notes 1 to 4, the extra-vehicle object detection unit includes a terminal position detection unit (1062) to detect a mobile terminal as the extra-vehicle object by detecting that the mobile terminal outside of the vehicle is within a range of a predetermined distance from the vehicle, and, when it is determined that the detected extra-vehicle object is the mobile terminal that is the qualified object, the door control instruction unit outputs the control signal for instructing the unlocking of the locked door.

### <Supplementary Note 6>

A door lock control device according to supplementary note 6 is the door lock control device described in any one of supplementary notes 1 to 5, and further includes an unlock instruction acceptance unit (1051) to accept an unlock instruction for permitting the unlocking of the locked door, and, when it is determined that the detected extra-vehicle object is an unqualified object that is not qualified to unlock the locked door, and when the unlock instruction is accepted, the door control instruction unit outputs the control signal for instructing the unlocking of the locked door.

### <Supplementary Note 7>

A door lock control device according to supplementary note 7 is the door lock control device described in any one of supplementary notes 1 to 6, and further includes a vehicle position acquisition unit (104) to acquire a current position of the vehicle, and, when the acquired current position arrives at a predetermined position, the door control instruction unit outputs the control signal for instructing the unlocking of the locked door.

### <Supplementary Note 8>

A door lock control device according to supplementary note 8 is the door lock control device described in any one of supplementary notes 1 to 7, and further includes an abnormality detection unit (1103) to detect an abnormality inside the vehicle, and, when the abnormality inside the vehicle is detected, the door control instruction unit outputs the control signal for instructing the unlocking of the locked door.

### <Supplementary Note 9>

A door lock control device according to supplementary note 9 is the door lock control device described in any one of supplementary notes 1 to 8, and further includes an object registration unit (1105) to register the qualified object.

### <Supplementary Note 10>

A door lock control device according to supplementary note 10 is the door lock control device described in any one of supplementary notes 1 to 8, and further includes an intra-vehicle object detection unit (101) to detect an intra-vehicle object that exists on a seat of the vehicle, and, when the detected intra-vehicle object is a child, the door control instruction unit outputs a control signal for instructing locking of a door closest to a seat on which the child sits.

### <Supplementary Note 11>

A door lock control device according to supplementary note 11 is the door lock control device described in any one of supplementary notes 1 to 8, and further includes an intra-vehicle object detection unit (101) to detect an intra-vehicle object that exists on a seat of the vehicle, and, when the detected intra-vehicle object is an animal other than a human, the door control instruction unit outputs a control signal for instructing locking of a door closest to a seat on which the animal sits.

### <Supplementary Note 12>

A door lock control device according to supplementary note 12 is the door lock control device described in any one of supplementary notes 1 to 8, and further includes an intra-vehicle object detection unit (101) to detect an intra-vehicle object that exists on a seat of the vehicle, and, when the detected intra-vehicle object is luggage, the door control instruction unit outputs a control signal for instructing locking of a door closest to a seat on which the luggage is placed.

### <Supplementary Note 13>

A door lock control device according to supplementary note 13 is the door lock control device described in any one of supplementary notes 1 to 12, and further includes a lock instruction acceptance unit (1052) to accept a lock instruction for locking a door closest to an empty seat, and the door control instruction unit outputs a control signal for instructing locking of the door closest to the empty seat on the basis of the accepted lock instruction.

### <Supplementary Note 14>

A door lock control method according to supplementary note 14 is a door lock control method performed by a door lock control device that includes an extra-vehicle object detection unit (102; 106), a qualification determination unit (1101), and a door control instruction unit (1104), and includes: a step (T1) of, by the extra-vehicle object detection unit, detecting an extra-vehicle object that approaches a door of a vehicle from outside the vehicle; a step (T2) of, by the qualification determination unit, determining whether or not the detected extra-vehicle object is a qualified object that is qualified to unlock a door that is locked, and outputting a determination result; and a step (T4) of, by the door control instruction unit, when the door that the detected extra-vehicle object approaches is a locked door that is locked, outputting a control signal for instructing an operation on the locked door on the basis of the output determination result, and, when it is determined that the detected extra-vehicle object is the qualified object, the door control instruction unit outputs a control signal for instructing unlocking of the locked door.

Note that the embodiments can be combined, and each embodiment can be modified or omitted as appropriate.

### INDUSTRIAL APPLICABILITY

The door lock control device according to the present disclosure can be used as part of a system that monitors passengers such as a driver in a vehicle.

### REFERENCE SIGNS LIST

1: intra-vehicle camera, 2: extra-vehicle camera, 3: door sensor, 4: locator, 5: display device, 6: vehicle antenna, 7: mobile terminal, 10: door lock control device, 10M: door lock control device, 21: actuator 100a: processing circuit, 100b: processor, 100c: memory, 101: intra-vehicle object detection unit, 102: extra-vehicle object detection unit, 103: door touch signal acquisition unit, 104: vehicle position acquisition unit, 106: extra-vehicle object detection unit, 110: determination instruction unit, 110M: determination instruction unit, 211: right front door, 212: right rear door, 213: left front door, 214: left rear door, 215: tail door, 1011: intra-vehicle monitoring unit, 1012: intra-vehicle image analysis unit, 1021: extra-vehicle monitoring unit, 1022; extra-vehicle image analysis unit, 1051: unlock instruction acceptance unit, 1052: lock instruction acceptance unit, 1061: communication unit, 1062: terminal position detection unit, 1101: qualification determination unit, 1102: door touch detection unit, 1103: abnormality detection unit, 1104: door control instruction unit, 1105: object registration unit

1-7. (canceled)

8. A door lock control device comprising:
processing circuitry
to detect an extra-vehicle object that approaches a door of a vehicle from outside the vehicle;
to determine whether or not the detected extra-vehicle object is a qualified object that is qualified to unlock a door that is locked, and output a determination result;
to output, when the door that the detected extra-vehicle object approaches is a locked door that is locked, a control signal for instructing an operation on the locked door on a basis of the output determination result;
to output, when it is determined that the detected extra-vehicle object is the qualified object, a control signal for instructing unlocking of the locked door;
to detect an abnormality inside the vehicle; and
to output, when the abnormality inside the vehicle is detected, the control signal for instructing the unlocking of the locked door.

9. (canceled)

10. A door lock control device comprising:
processing circuitry to detect an extra-vehicle object that approaches a door of a vehicle from outside the vehicle;
to determine whether or not the detected extra-vehicle object is a qualified object that is qualified to unlock a door that is locked, and output a determination result:
to output, when the door that the detected extra-vehicle object approaches is a locked door that is locked, a control signal for instructing an operation on the locked door on a basis of the output determination result;
to output, when it is determined that the detected extra-vehicle object is the qualified object, a control signal for instructing unlocking of the locked door;
to detect an intra-vehicle object that exists on a seat of the vehicle,
to output, when the detected intra-vehicle object is a child or an animal other than a human, a control signal for instructing locking of a door closest to a seat on which the child or animal sits.

11-14. (canceled)

15. A door lock control method comprising:
detecting an extra-vehicle object that approaches a door of a vehicle from outside the vehicle;
determining whether or not the detected extra-vehicle object is a qualified object that is qualified to unlock a door that is locked to output a determination result;
outputting, when the door that the detected extra-vehicle object approaches is a locked door that is locked, a control signal for instructing an operation on the locked door on a basis of the output determination result;
outputting, when it is determined that the detected extra-vehicle object is the qualified object, a control signal for instructing unlocking of the locked door;
detecting an intra-vehicle object that exists on a seat of the vehicle; and
outputting, when the detected intra-vehicle object is a child or an animal other than a human, a control signal for instructing locking of a door closest to a seat on which the child or animal sits.
